(19) United States
(12) Patent Application Publication
(10) Pub. No.: US 2005/0074601 A1
(43) Pub. Date: Apr. 7, 2005

(54) Image protective sheet, image protective solution, inkjet recorded product, and manufacturing method thereof

(75) Inventor: Hiroyuki Onishi, Nagano (JP)

Correspondence Address: Ladas & Parry, 26 West 61 Street, New York, NY, 10023, US

(73) Assignee: SEIKO EPSON CORPORATION

(21) Appl. No.: 10/402,369

(22) Filed: Mar. 28, 2003

(30) Foreign Application Priority Data
Mar. 28, 2002 (JP) 2002-092918
Mar. 26, 2003 (JP) 2003-85025

(51) Int. Cl. B32B 1/00

(52) U.S. Cl. 428/332

(57) ABSTRACT

The present invention provides an inkjet recorded product in which the advantages of a pigment ink with excellent image fastness are utilized by providing on an image portion of an inkjet recording medium an image protective sheet comprising a base and a protective layer thereon having a thickness of 1 to 20 μm and containing a thermoplastic resin and a lubricant component, or an image protective solution containing a resin emulsion and a lubricant component. The present invention also provides an inkjet recorded product comprising a protective layer that is impervious to surface damage.

### BACKGROUND OF THE INVENTION

1. Field of the Invention

The present invention relates to an image protective sheet for inkjet recorded images, to an image protective solution, to an inkjet recorded product, and to a manufacturing method thereof; and, more particularly, to an image protective sheet for protecting inkjet recorded images graphically formed with pigment ink, to an image protective solution, to an inkjet recorded product, and to a manufacturing method thereof.

2. Description of the Related Art

Inkjet techniques have come to be widely used in recent years as means whereby photographs, pictures, characters, and other images created by a personal computer or the like are recorded on paper and other recording media. Such inkjet recording methods are methods in which droplets of an ink composition are sprayed and deposited on a recording medium to perform printing. It has also recently become possible for high-resolution, high-quality images to be rapidly printed using relatively inexpensive equipment as a result of improvements in ink compositions and recording media.

Products obtained by dissolving or dispersing dyes, pigments, or other colorants in water or aqueous media containing alcohols or the like are commonly used as the inks for the above-described inkjet recording methods, and these products are broadly classed as dye inks and pigment inks. Dye inks, which have high reproducibility, high solubility in water, and other benefits, have been widely used so far.

Large amounts of inks are also used to form high-quality full-color images comparable to silver salt photographs as recording media designed for inkjet recording methods. For this reason, recording media in which an ink receiving layer based on silica, alumina, and other inorganic particulate pigments is formed on paper, film, or another substrate have come to be used in order to meet the need for high ink absorbency.

However, a problem has been pointed out in relation to images formed by dye inks on inkjet recording media provided with an ink receiving layer that discoloration and fading tend to occur and image fastness degrades over time due to the effect of water, moisture, ozone gas, or the like. Image fastness is being attached greater importance with increased use of the recent inkjet recording technologies in digital photographic services, commercial printing applications, and the like, and enhanced fastness has become an important topic for such inkjet recording technologies. In view of this, pigment inks, which have greater image fastness than do dye inks, have come to be used for inkjet recording.

However, images formed with a pigment ink are disadvantageous in that because the pigment is deposited on the immediate surface of the recording medium, shedding readily occurs and the scratch resistance is inadequate.

Japanese Patent Application Laid-open No. 2000-153677 discloses a known technique whereby a protective layer is formed by laminating a transparent film or the like to a recording surface having images that have been formed with a pigment ink on an inkjet recording medium in order to overcome the above-described shortcoming of increased shedding, and proposes a cold lamination processing technique in which a film that can be bonded at normal temperature is used, a heat lamination processing technique in which the film is pasted while heated, and the like.

However, it is indicated in relation to these lamination processing techniques that they are disadvantageous in that (1) folds and bubbles tend to form in the film during lamination, (2) highly smooth protective layers are difficult to form because the smoothness of the protective layers tends to be governed by the smoothness of the recording surface, and the like.

There are also the problems that, depending on the type or other attributes of the protective layer, the surface of the protective layer can easily be damaged, degrading the quality of the images formed by the pigment ink in the damaged section.

Pigment inks with better image fastness than that of dye inks are therefore used, as described above, but the surface damage of protective layers, the peeling of pigment inks induced by such damage, and other problems still remain unresolved, and an inkjet recorded product that combines adequate image fastness (long-term storage properties) with a high quality on a par with that of silver salt photography has yet to be realized.

In view of the above-described situation, therefore, it is a first object of the present invention to provide an image protective sheet for protecting inkjet recorded images formed of a pigment ink in which the advantages of the pigment ink having excellent image fastness are utilized.

Also, it is a second object of the present invention to provide an image protective solution for protecting inkjet recorded images formed of the pigment ink.

Further, it is a third object of the present invention to provide an inkjet recorded product that comprises a protective layer impervious to surface damage, wherein the inkjet recorded product has an image formed of the pigment ink.

Furthermore, it is a fourth object of the present invention to provide a method for manufacturing an inkjet recorded product that comprises a protective layer impervious to surface damage, wherein the inkjet recorded product has an image formed of the pigment ink.

### SUMMARY OF THE INVENTION

The first object is attained by means of an image protective sheet that comprises a base; and a protective layer having a thickness of 1 to 20 μm and containing a thermoplastic resin and a lubricant component on the base.

According to a preferred aspect of the present invention, the glass transition point of the thermoplastic resin in the image protective sheet is in the range of 20 to 120° C.

According to a preferred aspect of the present invention, the lubricant component in the image protective sheet is selected from the group consisting of calcium stearate, ammonium stearate, microcrystalline wax, polyethylene wax, and polyethylene/paraffin wax.

The second object is attained by means of an image protective solution the comprises a resin emulsion; and a lubricant component.

According to a preferred aspect of the present invention, the glass transition point of the resin emulsion in the image protective solution is in the range of −20 to 100° C.

According to a preferred aspect of the present invention, the lubricant component in the image protective solution is selected from the group consisting of calcium stearate, ammonium stearate, microcrystalline wax, polyethylene wax, and polyethylene/paraffin wax.

The third object is attained by means of an inkjet recorded product that has images formed with pigment ink on an inkjet recording medium comprising a support and an ink receiving layer on this support, comprising a protective layer provided on a surface of the recording medium on which the images are formed, the protective payer having a thickness of 1 to 20 μm and containing a thermoplastic resin and a lubricant component.

According to a preferred aspect of the present invention, the glass transition point of the thermoplastic resin in the inkjet recorded product is in the range of −20 to 120° C.

According to a preferred aspect of the present invention, the lubricant component in the inkjet recorded product is selected from the group consisting of calcium stearate, ammonium stearate, microcrystalline wax, polyethylene wax, and polyethylene/paraffin wax.

According to a preferred aspect of the present invention, the ink receiving layer in the inkjet recorded product contains a porous inorganic particle.

According to a preferred aspect of the present invention, the porous inorganic particle is selected from the group consisting of synthetic noncrystalline silica, colloidal silica, vapor-phase silica, alumina, colloidal alumina, pseudo-boehmite, and boehmite.

The fourth object of the present invention is attained by means of a method for manufacturing an inkjet recorded product that comprises an image formation step for forming an image by use of pigment ink on an ink receiving layer on a support of an inkjet recording medium, and a transfer step for transferring a protective layer having a thickness of 1 to 20 μm and containing a thermoplastic resin and a lubricant component onto the image.

The fourth object of the present invention is also attained by means of a method for manufacturing an inkjet recorded product, that comprises an image formation step for forming an image by use of pigment ink on an ink receiving layer on the support of an inkjet recording medium, a depositing step for causing a protective solution containing a resin emulsion and a lubricant component to deposit on the image, and a drying step for drying the protective solution.

According to a preferred aspect of the present invention, the lubricant component in the two aforementioned manufacturing methods is selected from the group consisting of calcium stearate, ammonium stearate, microcrystalline wax, polyethylene wax, and polyethylene/paraffin wax.

According to a preferred aspect of the present invention, the glass transition point of the thermoplastic resin in the manufacturing method comprising a transfer step is in the range of 20 to 100° C.

According to a preferred aspect of the present invention, the transfer step in the manufacturing method that comprises the transfer step is carried out by the thermal transfer of an image protective sheet comprising a protective layer on a base.

According to a preferred aspect of the present invention, the glass transition point of the resin emulsion in the manufacturing method that comprises a depositing step is in the range of −20 to 120° C.

According to a preferred aspect of the present invention, the depositing step in the manufacturing method that comprises the depositing step is carried out by an inkjet technique or liquid lamination technique.

According to a preferred aspect of the present invention, the ink receiving layer in the two aforementioned manufacturing methods contains a porous inorganic particle.

According to a preferred aspect of the present invention, the porous inorganic particle in the two aforementioned manufacturing methods is selected from the group consisting of synthetic noncrystalline silica, colloidal silica, vapor-phase silica, alumina, colloidal alumina, pseudo-boehmite, and boehmite.

According to the present invention, it is possible to provide an inkjet recorded product that has a recorded image based on pigment ink, wherein providing the recording surface of the recorded product with an image protective layer of specific thickness yields an inkjet recorded product in which the surface of the protective layer is impervious to damage and in which adequate image fastness can be ensured.

### BRIEF DESCRIPTION OF THE DRAWINGS

FIG. 1 shows a schematic cross-sectional view of an inkjet recorded product in accordance with the present invention;

FIG. 2 shows a schematic cross-sectional view of an essential part of a transfer apparatus that illustrates the transfer technique employed in the present invention;

FIG. 3 shows a perspective view of the recording head portion, which is an essential part of the inkjet recording apparatus used in the present invention;

FIG. 4 shows a schematic view illustrating an ink tank and an protective solution tank used in the invention shown in FIG. 3;

FIG. 5 shows a perspective view outlining an embodiment of the liquid lamination technique used in the present invention; and

FIG. 6 shows a cross-sectional view along line II-II in FIG. 5.

### DESCRIPTION OF THE PREFERRED EMBODIMENTS

Preferred embodiments of the inkjet recorded product according to the present invention will now be described in detail with reference to drawings.

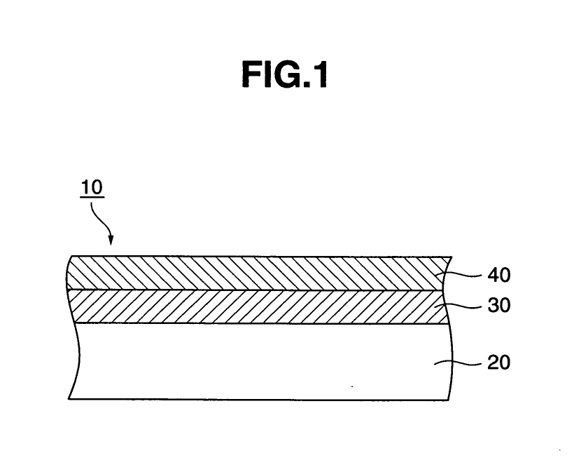

The inkjet recorded product 10 of an embodiment according to the present invention has an image protective layer 40 for covering an image (not shown) formed with an pigment ink on the ink receiving layer 30 of an inkjet recording medium that has the ink receiving layer 30 on a support 20, as shown in FIG. 1.

The material that can be used as the support 20 in the present invention is not limited in any particular way and includes premium grade paper, recycled paper, size-coated paper, and other types of paper; art paper, coated paper, cast-coated paper, resin-covered paper, resin-impregnated paper, and other types of processed paper; polyethylene, polypropylene, polystyrene, polyethylene terephthalate, and other film- or sheet-shaped plastic bases; nonwovens, wovens, metal films, metal sheets, and composite bases obtained by pasting these together; and sheet-shaped products commonly used as the bases in these types of coated paper.

In particular, paper or resin-covered paper (occasionally referred to as “resin-coated paper”), which is obtained by coating paper on at least one side with resin, is preferably used. Also, it is particularly preferable to use the support 20 having a high surface smoothness because of prevention of bubble contamination during protective layer deposition.

The ink receiving layer 30 used in the present invention preferably contains a porous inorganic particle and is a so-called void-type ink receiving layer that has innumerable minute voids on the surface thereof or in the layer itself. The porous inorganic particle is not limited in any particular way and may comprises, in addition to silica pigments obtained by precipitation, gelation, vapor-phase technology, or the like, materials such as smectite clay, calcium carbonate, calcium sulfate, barium sulfate, titanium dioxide, kaolin, china clay, talc, magnesium silicate, calcium silicate, aluminum oxide, alumina, pseudo-boehmite, and boehmite. Synthetic noncrystalline silica, colloidal silica, vapor-phase silica, alumina, colloidal alumina, pseudo-boehmite, boehmite, and other inorganic microparticulate pigment are particularly preferred.

The surface properties (feel, texture) of the ink receiving layer 30 used in the present invention are not limited in any particular way and may be appropriately adjusted to matt, semi-gloss, gloss, or the like.

Furthermore, the ink receiving layer 30 used in the present invention can be obtained by a process in which a coating solution composition containing the above-described porous inorganic microparticles and, if needed, polyvinyl alcohol or another binder resin or additives is dried after being applied in the usual manner to a support 20 with the aid of an air knife coater, roll coater, blade coater, gate roll coater, size press apparatus, or other publicly known application apparatus.

The ink receiving layer 30 pertaining to the present invention may be any layer that contains the aforementioned porous inorganic microparticles, with the following particularly preferred aspects.

The content of the porous inorganic microparticles in the ink receiving layer 30 is preferably from 30 to 90 wt %, and more preferably from 40 to 80 wt %. When the aforementioned binder resin is used, consumption thereof per 100 weight parts of the porous inorganic microparticles is preferably from 5 to 60 weight parts, and more preferably from 10 to 50 weight parts.

In addition, the thickness of the dried ink receiving layer 30 is preferably from 10 to 50 μm, and more preferably from 15 to 40 μm. In terms of dry weight, the application rate is preferably from 10 to 50 g/m², and more preferably from 15 to 40 g/m². Furthermore, the ink receiving layer 30 preferably has a void content of 20% or greater, as measured in accordance with J. TAPPI No. 48-85.

The image (not shown) on the ink receiving layer 30 is formed by ink-jetting with a pigment ink. The pigment ink is not limited in any particular way and may be any ink commonly used in an inkjet recording technique. The pigment ink is commonly an aqueous liquid obtained by adding a pigment, which is a colorant, to water. Various solvent components, surfactants, or the like are commonly added in an appropriate manner for the sake of penetration adjustment, humidification, viscosity adjustment, or the like.

Black, orange, green, and other colored inks, as well as light cyan, light magenta, and other so-called light inks or the like may also be used as needed in addition to the three colors yellow, magenta, and cyan as the pigment inks when color recording is performed.

The protective layer 40 for covering an image (not shown) formed as described above is transferred or deposited by the method described below.

The image protective layer 40 according to the present invention is a layer that serves as a protective layer when transferred or deposited on the recording surface of the ink receiving layer 30 on which the image is formed, and primarily comprises a resin and a lubricant component. A material that is highly transparent in addition to being able to form a film that resists discoloration by heat or light and has excellent chemical and physical barrier properties is preferably used as this resin. Specifically, the resin is preferably selected such that the light transmittance of the image protective layer 40 is preferably 80% or greater, and more preferably 90% or greater. The light transmittance can be measured in accordance with JIS K6714, JIS K7105, and ASTM D1003.

The resin may be a thermoplastic resin or the like and is not limited in any particular way, with preferred examples including acrylic resin, styrene resin, polyethylene resin, polycarbonate, urethane resin, cellulose resin, polypropylene, acetal resin, acrylonitrile-butadiene-styrene (ABS) resin, and polyester resin. One, two, or more types of these may be used.

A thickness of the image protective layer comprising this resin is preferably from 1 to 30 μm, more preferably from 1 to 25 μm, and even more preferably from 1 to 20 μm. When the thickness of the protective layer is 30 μm or greater, the protective layer itself loses flexibility, and cracks can easily be formed even by a slight outside force, whereas when the thickness is 1 μm or less, the protective layer becomes ineffective; that is, it loses its abrasion resistance and other functions.

In addition, the coefficient of friction between the protective layer and the inkjet recording medium is preferably a value of 2.0 or less, as measured in accordance with the JIS Standard P8147 (Method for Determining Coefficient of Friction). When the coefficient of friction is 2.1 or greater, the surface of the protective layer has low slipperiness and can be easily damaged.

Furthermore, the hardness of the protective layer is preferably a value of 2 H or greater, as measured by the JIS Standard K5600 (Pencil Hardness). When the hardness is less than 2H, the surface of the protective layer is weak, and can therefore be easily damaged.

Examples of the lubricant component that constitutes the image protective layer 40 according to the present invention include calcium stearate, ammonium stearate, microcrystalline wax, polyethylene wax, and polyethylene/paraffin wax. Such lubricant components may be used singly or as combinations of two or more types of components. The presence of this lubricant component renders the protective layer flexible and makes the surface thereof more resistant to damage.

One, two, or more types of additives such as water resistance improvers, light resistance improvers, gas resistance improvers, scratch resistance improvers, antioxidants, UV absorbers, preservatives, antibiotics, and leveling agents may also be contained as needed.

Methods of transferring or depositing the protective layer 40 pertaining to the present invention will now be described. There are two broad groups of the transferring or depositing methods used in the present invention. One is a group of methods whereby a sheet-shaped image protective sheet is thermally transferred onto an inkjet recording medium. In this case, the image protective sheet contains a thermoplastic resin and the above-described lubricant component. The glass transition point of the thermoplastic resin is preferably in the range of 20 to 120° C.

The other is a group of methods whereby a liquid image protective solution is deposited on an inkjet recording medium by an inkjet technique, liquid lamination technique, or the like. In this case, the image protective solution contains a resin emulsion and the above-described lubricant component.

The term “resin emulsion” used herein refers to a water-base dispersion of polymer microparticles insoluble or poorly soluble in water. In particular, the emulsion serves the function to improve fixation properties of the pigment ink deposited on the inkjet recording medium, and to preserve images in which the pigment ink has excellent scratch resistance.

Specific examples of such polymers include polyolefins, polystyrene, polymethacrylate (Bonron Series (registered trade name), manufactured by Mitsui Chemicals; Primal Series (registered trade name), manufactured by Rohm & Haas Japan; Nacrylic Series (registered trade name), manufactured by Nippon NSC; Vinyblan Series (registered trade name), manufactured by Nissin Chemical; Acryset Series (registered trade name), manufactured by Nippon Shokubai; Acrit Series (registered trade name), manufactured by Taisei Kako; Aquabrid Series (registered trade name), manufactured by Daicel Chemical; and Polysol Series (registered trade name), manufactured by Showa Highpolymer), vinyl acetate resin (for example, Nicasol Series (registered trade name), manufactured by Nippon Carbide Industries; and Cevian Series (registered trade name), manufactured by Daicel Kaseihin), ethylene/vinyl acetate polymers (Mowinyl Series (registered trade name), manufactured by Clariant Polymer; Denka EVA TEX (registered trade name), manufactured by Denki Kagaku Kogyo; Sumikaflex Series (registered trade name), manufactured by Sumitomo Chemical; and Polysol Series (registered trade name), manufactured by Showa Highpolymer), styrene/acrylic copolymers (Rikabond series (registered trade name), manufactured by Chuo Rika Kogyo; and Polymaron Series (registered trade name), manufactured by Arakawa Industry), carboxyl-modified styrene/butadiene copolymers (JSR Series (registered trade name), manufactured by JSR), polyesters, polyvinyl ether, polyamide polyurethane, polyethylene acrylic resins, acrylic acid ester resins, and other plastic pigments, emulsions (including copolymers), and core-shell crosslinked polymer microparticles.

Other specific examples of the aforementioned polymers include one, two, or more types of polymers selected from the group consisting of polymers based on acryl, methacryl, styrene, urethane, acrylamide, and epoxy, of which those based on acryl, methacryl, styrene, and mixtures thereof are preferred in particular. Specific examples include styrene, tetrahydrofurfuryl acrylate, butyl methacrylate, (α-2,3 or 4)-alkyl styrene, (α-2,3 or 4)-alkoxystyrene, 3,4-dimethyl styrene, α-phenyl styrene, divinyl benzyl, vinyl naphthalene, dimethylamino(meth)acrylate, dimethylaminoethyl(meth)acrylate, dimethylaminopropyl acrylamide, N,N-dimethylaminoethyl acrylate, acryloyl morpholine, N,N-dimethylacrylamide, N-isopropyl acrylamide, N,N-diethyl acrylamide, methyl(meth)acrylate, ethyl(meth)acrylate, propyl(meth)acrylate, ethyl hexyl(meth)acrylate, and other alkyl(meth)acrylates; methoxydiethylene glycol(meth)acrylate diethylene glycols having ethoxy, propoxy, or butoxy groups, (meth)acrylates of polyethylene glycol, cyclohexyl(meth)acrylate, benzyl(meth)acrylate, phenoxyethyl(meth)acrylate, isobonyl(meth)acrylate, hydroxyalkyl(meth)acrylate, and other fluorine-, chlorine-, and silicon-containing (meth)acrylates; (meth)acrylamides; and maleamides. Examples of compounds that may be used when crosslinked structures are introduced in addition to (meth)acrylic acid and other monofunctional compounds include (mono, di, tri, tetra, poly)ethylene glycol di(meth)acrylate, 1,4-butanediol, 1,5-pentanediol, 1,6-hexanediol, 1,8-octanediol, 1,10-decanediol, and other (meth)acrylates, as well as trimethylol propane tri(meth)acrylate, glycerol (di, tri)(meth)acrylate, di(meth)acrylates of ethylene oxide adducts of bisphenol A or bisphenol F, neopentyl glycol di(meth)acrylate, pentaerythritol tetra(meth)acrylate, and dipentaerythritol hexa(meth)acrylate.

The average particle diameter of the polymer microparticles constituting the emulsion is preferably from 50 to 250 nm, and particularly from 60 to 120 nm, because of considerations related to the dispersion stability thereof.

Either a monophase structure or a heterophase structure (core-shell type) may be used for the polymer microparticles, and the polymer microparticles based on a core-shell structure is particularly preferred from the standpoint of dispersion stability.

The glass transition point of the resin emulsion is preferably in the range of −20 to 100° C. The glass transition point is measured in accordance with JIS K 6900.

Methods for manufacturing an inkjet recorded product according to the present invention will now be described in detail.

### First Embodiment

The first embodiment in accordance with the present invention is described with reference to a method for manufacturing an inkjet recorded product in which an image protective sheet is thermally transferred onto an inkjet recording medium.

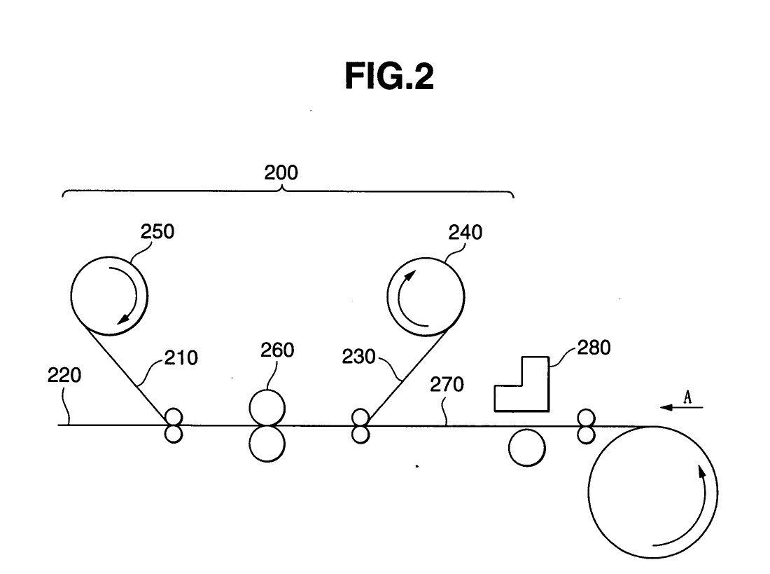

FIG. 2 illustrates a schematic cross-sectional view of an essential part of a transfer apparatus that demonstrates the transfer of the image protective sheet according to the present invention.

The transfer apparatus 200, which is applied to the present invention, comprises an image protective sheet transport mechanism and a pressure means 260. The image protective sheet transport mechanism comprises an image protective sheet feeding means 240 and a peeling means 250, the means 240 comprising an image protective sheet 230 having a protective layer 220 on a base 210, which is wound as a continuous sheet, and the means 250 performing the function to take up the base 210 after the image protective layer 220 passing through the transfer step has been peeled off. The pressure means 260 serves the functions to transfer and bond the image protective layer 220 of the image protective sheet 230 to a recording surface that has the recorded image of an inkjet recording medium. In preferred practice, the pressure means 260 further comprises a heater or other heating means in order to promote the transfer of the image protective layer 220. The image protective layer 220 of the image protective sheet 230 is transferred to the inkjet recording medium 270 having a recorded image by the thermocompression bonding action of the pressure means 260.

The transfer apparatus 200 is preferably provided with a cutter or other cutting means (not shown) as needed when the image protective sheet 230 is a continuous sheet. The inkjet recorded product with the transferred image protective layer 220 is adjusted to the desired length by the cutting means.

The image protective sheet feeding means 240 comprises a roller whereby the image protective sheet 230 wound into a roll configuration can be fed in the transport direction of arrow A in FIG. 2.

The pressure means 260 comprises a pair of rollers and applies pressure to the sheet-shaped product passing between the rollers.

The pressure conditions used during transfer should be adequately adjusted with consideration for the thickness and other attributes of the image protective layer 220. In terms of a linear pressure, these conditions are preferably from 0.1 to 10 kN/m, and more preferably from 0.2 to 5 kN/m. Heating is preferably used as needed in order to facilitate the transfer of the image protective layer 220.

The peeling means 250 comprises a takeup roller and can take up the base 210 after the image protective layer 220 has been transferred to the inkjet recording medium 270.

The image protective sheet 230 comprises a base 210 and a protective layer 220 provided on the base, as described above. No particular restrictions are imposed on the material for the base 210, and it is possible to use a material commonly employed as a base for a transfer sheet such as the image protective sheet 230 according to the present invention. It is possible, for example, to use polyethylene terephthalate (PET), 1,4-polycyclohexylene dimethylene terephthalate, polyethylene naphthalate (PEN), polyphenylene sulfide (PPS), polyether sulfone (PES), polystyrene, polypropylene, aramid, polycarbonate, polyvinyl alcohol, cellophane, cellulose acetate, other cellulose derivatives, polyethylene polyvinyl chloride, nylon, polyimide, ionomers, and other resin films; condenser paper, paraffin paper, and other types of paper; nonwoven fabrics; and composite films comprising paper or nonwoven fabric and resin film. Among these, PET is preferred for use from the standpoint of cost and peeling properties. Products obtained by subjecting the base material to a corona discharge treatment, antistatic treatment, release treatment, or the like may also be used in order to control adhesive properties in relation to the protective layer. Furthermore, products in which the side to be bonded to the protective layer is embossed may also be used in order to control the surface properties (including matt, gloss, semi-gloss, embossed, and the like) of the protective layer.

The thickness of the base 210 is not limited in any particular way, but is preferably from 10 to 200 μm, and more preferably from 15 to 80 μm, from the standpoint of cost and peeling properties.

The following procedure may be used to manufacture the image protective sheet 230 that has a protective layer 220 and is used in the transfer technique employed in the present invention.

The aforementioned resin and lubricant component for forming a protective layer are first dissolved or dispersed in an appropriate solvent based on water, organic solvent, or the like, and additives are added as needed to prepare a protective solution, which is dried after being applied to the base 210, yielding a protective layer 220. In the process, the thickness of the image protective layer can be controlled to the desired level of thickness by selecting the concentration of the protective solution in an appropriate manner.

It is also possible to form an adhesive layer (not shown) by applying and drying a pressure-sensitive adhesive on the protective layer 220 in accordance with an ordinary method as needed. The pressure-sensitive adhesive layer is a layer for fixing the image protective layer 220 on the ink receiving layer of the inkjet recording medium, allowing for easy bonding with the surface of the ink receiving layer by weak pressure such as that developed by light pressing.

The inkjet recording medium 270 wound into a roll configuration is used to obtain an inkjet recording medium 270 whose recorded image is formed of the pigment ink by inkjet recording means 280 on the basis of entered image information, as shown in FIG. 2. The inkjet technique may be one that uses a piezoelement, one that uses a heating element, or the like, and is not limited in any particular way in the present invention.

The image protective layer 220 can be deposited on the recording surface of the inkjet recording medium when the recording surface of the inkjet recording medium 270 and the protective layer 220 or pressure-sensitive adhesive layer of the image protective sheet 230 are superposed with each other and passed between a pair of rollers, which are the pressure means 260 in FIG. 2. The base 210 from which the image protective layer 220 has been peeled off is then taken up by the peeling means 250.

Although an image protective sheet in which a single image protective layer was provided to a base was described above, the object of the present invention can also be attained with an image protective sheet in which two protective layers are provided to the base. In such cases, the protective layer the closest to the base, which is one of the protective layers constituting the image protective sheet, should contain a thermoplastic resin and a lubricant component. Specifically, the image protective layer containing a thermoplastic resin and a lubricant component is disposed on the immediate surface when an image protective sheet is thermally transferred to an inkjet recording medium. An inkjet recorded product whose surface is impervious to damage can be provided as long as the protective layer on the immediate surface is an image protective layer containing a thermoplastic resin and a lubricant component, allowing the other protective layers to be composed of any resin without any regard for whether it is a thermoplastic resin, thermosetting resin, or any other type of resin. The image protective sheet according to the present invention may have three or more layers as long as the objects of the present invention are not compromised. When three or more layers are provided in this manner, the immediate surface layer of the protective layer thermally transferred to an inkjet recording medium should be an image protective layer that contains a thermoplastic resin and a lubricant component.

### Second Embodiment

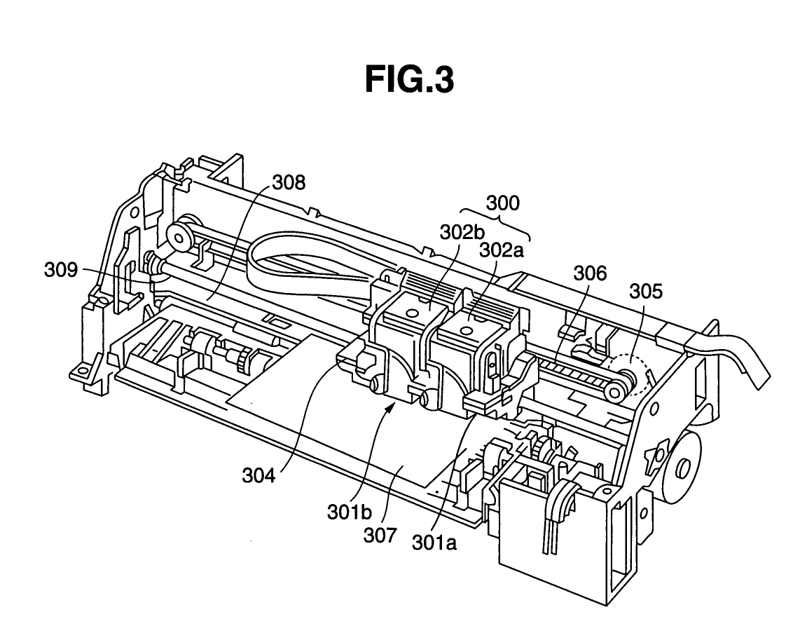

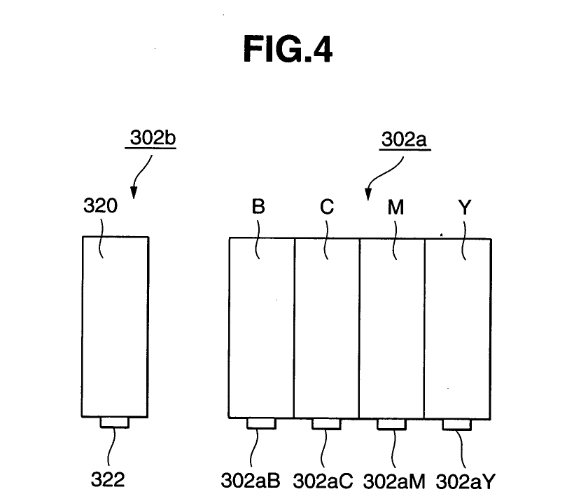

FIG. 3 shows a perspective view illustrating a method for depositing the image protective solution for forming an image protective layer by an inkjet technique. FIG. 4 shows a diagram illustrating an ink tank and a protective solution tank for image protection used in the inkjet technique. The inkjet technique may be one that uses a piezoelement, one that uses a heating element, or the like, and is not limited in any particular way in the present invention.

The recording head unit 300 comprises an ink ejection port 301a and protective solution ejection ports 301b, an ink tank 302a and a protective solution tank 302b linked in a liquid transmitting state with the ejection ports, a carriage 304 for mounting the tanks, a timing belt 306 for moving the carriage 304, and a motor 305 for driving the timing belt 306, as shown in FIG. 3.

The carriage 304 is provided with the ejection ports 301a and 301b and is configured such that the ejection ports 301a and 301b and the tanks 302a and 302b are mounted in a liquid transmitting state. An inkjet recording medium 307 is moved by a platen 308 and a guide 309 to allow the recording area to be positioned facing the recording head unit 300.

Four ink chambers Y, M, C, and B for storing yellow, magenta, cyan, and black inks are arranged in parallel in the ink tank 302a used in the present embodiment. The ink tanks are provided with the corresponding ink feed ports 302aY, 302aM, 302aC, and 302aB, which lead from each ink chamber to the ink ejection port 301a.

The image protective solution tank 302b comprises a protective solution chamber 320 and a protective solution feed port 322, which leads from the protective solution chamber to the protective solution ejection ports 301b. Liquids can be transmitted between the protective solution feed port 322 and the protective solution ejection ports 301b.

Following is a specific example of an inkjet recorded product formed by the inkjet technique that uses the inkjet recording apparatus of the present embodiment.

The inkjet recording medium 307 is first set in paper feed means (not shown), and the recording medium 307 is moved by means of the platen 308 and the guide 309 to a position opposite from the recording head unit 300. Ink of the desired color is ejected from the ink ejection port 301a onto the inkjet recording medium 307 on the basis of image signals transmitted from a personal computer or the like, and recorded images are formed on the inkjet recording medium 307.

The above-described image protective solution is ejected from the protective solution ejection ports 301b and deposited on the inkjet recording surface of the inkjet recording medium 307, and a protective layer for covering the image is formed on the inkjet recording medium 307 on which the recorded image has been recorded in this manner.

Here, the image protective solution may be ejected across the entire surface of the inkjet recording medium 307, or it may be selectively deposited solely in the ink ejection area in which the ink has been ejected from the recording head unit 300.

In addition, the image protective solution is preferably controlled such that the ejection rate of the image protective solution is kept at from 1 pL to 40 pL to form an image protective layer with a thickness of from 1 to 20 μm.

The above description is given with reference to an image protective solution that pertained to the present invention and is used to form a single protective layer, but the objects of the present invention can also be attained with any arrangement in which the immediate surface image protective layer formed on the inkjet recording medium 307 is an image protective layer formed from the image protective solution according to the present invention. For this reason, it is also possible with the present invention to provide an inkjet recorded product in which two or more protective layers are formed on an inkjet recording medium, wherein the immediate surface protective layer of the inkjet recorded product is formed from the image protective solution according to the present invention, as long as the objects of the present invention are not compromised.

### Third Embodiment

According to the present invention, the desired image is formed by an inkjet technique on an inkjet recording medium, and an image protective layer is then deposited in a film on the image by the liquid lamination technique described below.

The steps up to the formation of a recorded image from pigment ink on an inkjet recording medium are the same as in the preceding second embodiment, and will therefore be omitted from the description.

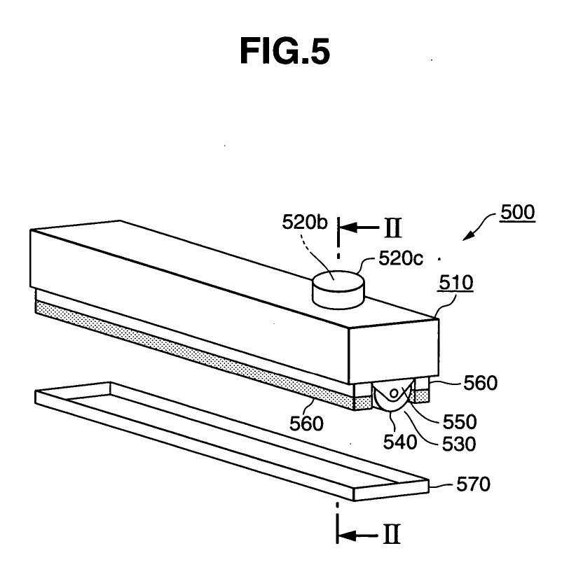

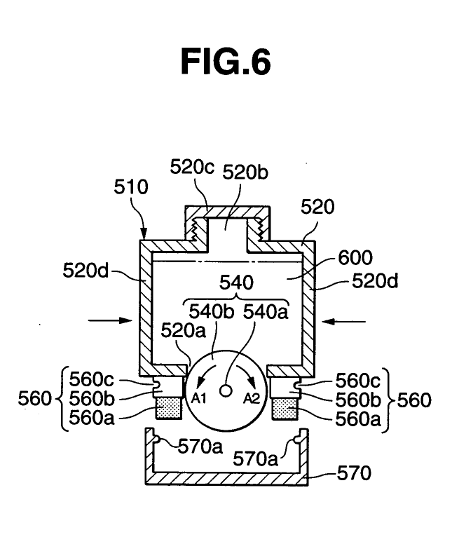

FIG. 5 shows a perspective view outlining an embodiment of the liquid lamination technique used in the present invention, and FIG. 6 shows a cross-sectional view along line II-II in FIG. 5.

In the liquid lamination apparatus 500 used in the present invention, the face of the recording surface of a recording medium on which a recorded image is formed of the pigment ink is treated with the image protective solution 600 pertaining to the present invention, a protective layer is deposited, and the image is covered.

The liquid lamination apparatus 500 is provided with protective solution application means 540 whereby the image protective solution 600 according to the present invention is applied while kept in direct contact with the face of the recording surface that has the recorded image, as shown in FIGS. 5 and 6.

The apparatus 500 comprises a protective solution application apparatus 510 provided with a tank member 520 for storing the image protective solution 600 according to the present invention, and an application head 530 having a protective solution application means 540. The apparatus 500 is filled with the liquid image protective solution 600. In the present embodiment, the protective solution application means 540 comprises a roller-shaped member 540.

In the present embodiment, the tank member 520 has a rectangular shape, and has a rectangular orifice 520a underneath thereof. The orifice 520a is adapted to be able to press along the inside edges thereof against the external peripheral surface of the roller-shaped member 540 as a protective solution application means 540 to prevent the image protective solution contained therein from leaking outside.

A makeup port 520b for making up the image protective solution is formed in the tank member 520. The makeup port 520b is cylindrical in shape and is formed in the top portion of the tank member 520. In addition, a makeup port cap 520c is detachably engaged with the makeup port 520b.

The application head 530 comprises a roller-shaped member 540 formed on the bottom side of the tank member 520 and designed as a protective solution application means 540, a holding element 550 for rotatably holding the roller-shaped member 540, and wiping means 560 that comprises an elastic member 560a and acts to wipe off any excess of the image protective solution 600 applied to the face of the recording surface.

The roller-shaped member 540 comprises a center axis 540a and a roller main body 540b, and has a cylindrical configuration aspect as a whole.

The holding element 550 is mounted in two longitudinally arranged end portions underneath the tank member 520 so as to support the center axis 540a of the roller-shaped member 540. The holding element 550 has a substantially triangular shape, and the center axis 540a is rotatably supported in the distal portion thereof.

The wiping means 560 comprises an elastic member 560a and an elastic member holding member 560b for holding the elastic member 560a. The elastic member holding member 560b is a substantially rectangular frame into which the elastic member 560a is inserted. Since a member that is somewhat larger than the internal dimensions of the elastic member holding member 560b is used for the elastic member 560a, the elastic member 560a is inserted into the elastic member holding member 560b in a somewhat compressed state, and the elastic member 560a is held without falling.

The wiping means 560 is preferably provided so as to be positioned backward in the direction of rotation of the roller-shaped member 540. In the present embodiment, the roller-shaped member 540 can rotate either in rotation direction A1 or in rotation direction A2 in FIG. 6, making it possible to adopt a configuration in which the wiping means 560 is mounted on two external sides in the radial direction of the roller-shaped member 540, and is positioned backwardly in the direction of rotation when the roller-shaped member 540 rotates in either direction.

A configuration is also adopted such that a cap member 570 for protecting the application head 530 is detachably fastened to the application head 530. In the present embodiment, the cap member 570 is a rectangular box-shaped body in which the entire top surface is open, with projections 570a provided to the orifice side of the wall portions in the longitudinal direction thereof so as to fit in the indentations 560c formed in the surfaces on the outside of the tank member 520 of the elastic member holding member 560b.

The liquid lamination apparatus 500 used in the present invention comprises application rate adjustment means for adjusting the application rate of the image protective solution 600 from the protective solution application means 540. Specifically, the application rate adjustment means in the present embodiment is formed by configuring the wall portions 520d of the tank member 520 such that elasticity is provided. Because the wall portions 520d are formed such that elasticity is provided, the wall portions 520d can be collapsed in the arrowed direction in FIG. 6 by pressing the wall portions 520d in the arrowed direction in FIG. 6. The pressure inside the tank member thereby increases over the contact pressure between the orifice 520a and the roller main body 540b, allows the protective solution to leak out through the contact between the orifice 520a and the roller main body 540b, and hence makes it possible to adjust the application rate.

Techniques used with ordinary containers or the like can be used herein without any particular limitations in order to endow the wall portions 520d of the tank member 520 with elasticity. Specifically, elasticity can be ensured by using a highly elastic material as the material for forming the tank member 520, or by adjusting the thickness and height of the wall portions 520d of the tank member 520.

The concentration and application rate of the protective solution can be appropriately selected because the thickness of the image protective layer deposited on the image recording surface is kept at from 1 to 30 μm, more preferably from 1 to 25 μm, and even more preferably from 1 to 20 μm, as described above. In addition, the optimum amount can be applied to the recording surface by using the wiping means 560 in the apparatus 500.

Following is a description of the preferred materials for each of the members described above.

The elastic member 560a in the liquid lamination apparatus 500 of the present embodiment comprises a spongy member. Examples of such spongy members include cotton, polyurethane, and sponge.

The roller main body 540b in the roller-shaped member 540 is preferably configured so as not to impede the rotation properties of the roller and to have sufficient sealing properties to be able to press against the orifice 520a and to prevent the contents from leaking out.

A product obtained by dissolving or dispersing a lubricant component and an acrylic resin, styrene-based resin, vinyl acetate resin, or the like can be appropriately used as the image protective solution 600 used in the liquid lamination technique.

The tank member 520 is preferably formed from a material that is insoluble in the protective solution. Metal, plastic, or another publicly known material may be used herein as the insoluble material without limitations.

In the apparatus 500, the cap member 570 is taken off and the application head 530 is exposed by disengaging the projections 570a fitted into the indentations 560c, and the roller-shaped member 540 and the wiping means 560 are brought into direct contact with the recording surface of the inkjet recording medium to make it possible to apply the image protective solution 600 and to remove any excess of the protective solution while pressure is applied to the wall portions 520d to adjust the application rate. With this arrangement, the treatment designed to protect an image formed by an inkjet technique can be carried out safely and easily.

The image protective layer formed by the liquid lamination technique used in the present invention may also comprise two or more layers as long as the objects of the present invention are not compromised. When a protective layer comprising two or more layers is deposited, the immediate surface protective layer of the protective layer formed on the inkjet recording medium is formed from the image protective solution pertaining to the present invention.

The present invention is described in greater detail by means of the embodiments shown below, but the scope of the present invention is not limited by these embodiments. Unless indicated otherwise, the term “%” used in the description refers to percent by weight.

### Embodiment 1

A 38-μm PET film was dried after being coated with an image protective solution comprising 95% of acrylic emulsion (Aquabrid 45592, registered trade name (Tg: 80° C.; manufactured by Daicel Chemical)) and 5% of polyethylene wax (Nopcoat PEM-17; solid content: 40%) as a lubricant in a dry thickness of 10 μm to produce an image protective sheet.

A photographic image was printed on photographic paper with the aid of a six-color pigment ink by using an inkjet printer MC-2000 manufactured by Seiko-Epson, the above-described image protective sheet on the PET film was laminated with the aid of a commercial laminator, and the PET was then peeled off, yielding an inkjet recorded product 1 (also referred to hereinbelow as “IJ recorded product 1”). The temperature during lamination was about 100° C.; the rate, 10 mm/sec.

### Embodiment 2

The surface of a 38-μm PET film was subjected to a silicone release treatment, and an image protective solution comprising 95% of acrylic emulsion (Aquabrid 45592, registered trade name (Tg: 80° C.; manufactured by Daicel Chemical)) and 5% of polyethylene wax (Nopcoat PEM-17; solid content: 40%) as a lubricant was dried after being applied in a dry thickness of 10 μm in the same manner as in embodiment 1.

An acrylic adhesive was further applied in a thickness of 10 μm, inkjet recording was performed under the same conditions as in embodiment 1, the sheet was laminated, and the PET film was peeled off, yielding IJ recorded product 2.

### Embodiment 3

Protective solution 1 having the following composition was introduced into the black-ink cartridge of an inkjet printer PM-800C manufactured by Seiko-Epson.

Protective solution 1

| | |
|---|---|
| Core-shell μ-emulsion Acrit WEM-210 | 30% |
| (solids concentration: 33%, Tg: 33° C.) | |
| Glycerol | 20% |
| Triethylene glycol monobutyl ether | 5% |
| Lubricant (polyethylene/paraffin wax Nopcomaru | 4% |
| MS40, San Nopco Limited, solid concentration 40%) | |
| Water | Balance |

A photographic image was printed on PM photographic paper by a color inkjet printer MC2000 with a six-color pigment ink, and the protective solution introduced into the aforementioned black-ink cartridge was then used to create an overcoat with PM800C on the aforementioned photographic image, yielding IJ recorded product 3.

### Embodiment 4

IJ recorded product 4 was obtained in which a photographic image was printed using a six-color pigment ink with the aid of an inkjet printer MC2000 manufactured by Seiko-Epson, and an image protective layer was then formed with the aid of a liquid laminator (ACCU-16, manufactured by ACCUTECH (USA)) by using protective layer 2 with the following composition.

Protective solution 2

| | |
|---|---|
| Core-shell microemulsion Acrit WEM-210 | 50% |
| Microcrystalline wax (Nopco 1245-M-SN; | 5% |
| solids: 46% San Nopco Limited) | |
| Water | Balance |

### COMPARATIVE EXAMPLE 1

IJ recorded product 5 was obtained in which a photographic image was printed on photographic paper by using a six-color pigment ink with the aid of an inkjet printer MC2000 manufactured by Seiko-Epson without providing any image protective layer.

[Evaluation of Inkjet Recorded Products]

The glossiness, gloss uniformity, scratch resistance, and gas resistance of inkjet (IJ) recorded products 1 to 5 were evaluated by the methods described below. The results are summarized in Table 1 below.

[Evaluation of Glossy Appearance]

The 60-degree specular gloss of a non-print portion in each inkjet recorded product was measured using the gloss meter PG-1 (manufactured by Nippon Denshoku). Higher values correspond to a better glossy appearance.

[Evaluation of Gloss Uniformity]

The gloss difference between the maximum concentration color and 1.0 as the O. D. value of Y, M, C, R, G, B, and Bk was determined for each of the inkjet recorded products, and the results were evaluated using the following evaluation criteria.

<Evaluation Criteria>

A: Gloss difference is less than 5. Satisfactory gloss uniformity

B: Gloss difference 5 or greater but less than 15. Limit of practical usefulness

C: Gloss difference 15 or greater but less than 20. Cannot be used

[Evaluation of Scratch Resistance]

A rubber eraser (width: 20 mm) was placed at an inclination of 60 degrees on the protective layer (embodiments 1 to 4) or ink receiving layer (comparative example 1) of each of the inkjet recorded products, a 1-kg load was applied from the top to the rubber eraser, the protective layer or ink receiving layer was rubbed ten times with the rubber eraser, the surface condition of the protective layer or ink receiving layer was visually observed thereafter, and an evaluation was made based on the following evaluation criteria.

[Evaluation Criteria]

A: No damage or peeling on the surface. Good scratching resistance

B: Damage on the surface. No problems in terms of actual use

C: Ink peels from the surface. Cannot be used practically

[Evaluation of Gas Resistance]

Each of the inkjet recorded products was introduced into a glass container equipped with a gas inlet and an exhaust port, and ozone gas that was generated by a gas generator was continuously introduced into the glass container for 100 hours at 1 ppm to perform a gas treatment. The color difference of a cyan-colored print portion on each of the inkjet recorded products before and after the gas treatment was determined using a color difference meter, and an evaluation was made based on the following evaluation criteria.

[Evaluation Criteria]

A: Color difference less than 5. Good gas resistance

B: Color difference 5 or greater but less than 15. No problems in terms of gas resistance

C: Color difference 15 or greater but less than 20. Limit of practical usefulness

D: Color difference 20 or greater. Cannot be used practically

TABLE 1

| | | GLOSS | SCRATCH | SCRATCH | GAS |
|---|---|---|---|---|---|
| | GLOSSINESS | UNIFORMITY | RESISTANCE | RESISTANCE¹⁾ | RESISTANCE |
| IJ RECORDED | 80 | A | A | B | A |
| PRODUCT 1 | | | | | |
| IJ RECORDED | 80 | A | A | B | A |
| PRODUCT 2 | | | | | |
| IJ RECORDED | 80 | A | A | B | A |
| PRODUCT 3 | | | | | |
| IJ RECORDED | 80 | A | A | B | A |
| PRODUCT 4 | | | | | |
| IJ RECORDED | 40 | C | C | | B |
| PRODUCT 5 | | | | | |

¹⁾The data for IJ recorded products 1 to 4 indicate the scratch resistance of inkjet recorded products that have a protective layer based on a lubricant-free image protective sheet or protective solution.

The results in Table 1 above indicate that an inkjet recorded product according to the present invention is treated in a manner such that the face of the recording surface is covered with an image protective layer; that is, the recording surface of an inkjet recorded medium is provided with an image protective layer that covers the image formed by pigment ink, and the image protective layer has the desired thickness, whereby the protective layer as such is impervious to damage and provides excellent image fastness.

1. An image protective sheet provided on a surface of an inkjet recording medium the medium comprising a support and an ink receiving layer on the support said image protective sheet comprising:
a protective layer having a thickness of 1 to 20 mm and containing a thermoplastic resin and a lubricant component wherein the coefficient of friction, between the protective layer and the inkiet recording medium is a value of 2.0 or less as measured with JIS Standard P8147.

2. The image protective sheet according to claim 1, wherein the glass transition point of the thermoplastic resin is in the range of 20 to 120° C.

3. The image protective sheet according to claim 1, wherein the lubricant component is selected from the group consisting of calcium stearate, ammonium stearate, microcrystalline wax, polyethylene wax, and polyethylene/paraffin wax.

4. An image protective solution comprising:
a resin emulsion comprising an acrylic resin, said resin emulsion being suitable for use on an inkjet recording medium to improve a fixation of pigment deposited on the medium; and
a lubricant component selected from the group consisting of calcium stearate, ammonium sterate, microcrystalline wax, polyethylene wax and polyethylene/paraffin wax.

5-6. (cancelled)

7. An inkjet recorded product having images formed with pigment ink on an inkjet recording medium comprising a support and an ink receiving layer on the support, comprising:
a protective layer provided on a surface of the recording medium on which the images are formed, said protective layer having a thickness of 1 to 20 mm and containing a thermoplastic resin and a lubricant component, wherein the coefficient of friction between the protective layer and the inkjet recording medium is a value of 2.0 or less as measured with JIS Standard P8147.

8. The inkjet recorded product according to claim 7, wherein the glass transition point of the thermoplastic resin is in the range of −20 to 120° C.

9. The inkjet recorded product according to claim 7, wherein the lubricant component is selected from the group consisting of calcium stearate, ammonium stearate, microcrystalline wax, polyethylene wax, and polyethylene/paraffin wax.

10. The inkjet recorded product according to claim 7, wherein the ink receiving layer contains a porous inorganic particle.

11. The inkjet recorded product according to claim 10, wherein the porous inorganic particle is selected from the group consisting of synthetic noncrystalline silica, colloidal silica, vapor-phase silica, alumina, colloidal alumina, pseudo-boehmite, and boehmite.

12. A method for manufacturing an inkjet recorded product, comprising the steps of:
forming an image by use of a pigment ink on an ink receiving layer on a support of an inkjet recording medium; and
transferring a protective layer having a thickness of 1 to 20 mm and containing a thermoplastic resin and a lubricant component onto the image, wherein the coefficient of friction between the protective laver and the inkjet recording medium is a value of 2.0 or less as measured with JIS Standard P8147.

13. A method for manufacturing an inkjet recorded product, comprising the steps of:
forming an image by use of a pigment ink on an ink receiving layer on the support of an inkjet recording medium;
depositing a protective solution containing a resin emulsion and a lubricant component on the image; and
drying the protective solution, wherein the coefficient of friction between the protective layer and the inkjet recording medium is a value of 2.0 or less as measured with JIS Standard P8147.

14. The manufacturing method according to claim 12, wherein the lubricant component is selected from the group consisting of calcium stearate, ammonium stearate, microcrystalline wax, polyethylene wax, and polyethylene/paraffin wax.

15. The manufacturing method according to claim 12, wherein the glass transition point of the thermoplastic resin is in the range of 20 to 120° C.

16. The manufacturing method according to claim 12, wherein the transfer step is carried out by the thermal transfer of an image protective sheet comprising a base and a protective layer thereon.

17. The manufacturing method according to claim 13, wherein the glass transition point of the resin emulsion is in the range of −20 to 120° C.

18. The manufacturing method according to claim 13, wherein the depositing step is carried out by an inkjet technique or a liquid lamination technique.

19. The manufacturing method according to claim 12, wherein the ink receiving layer contains a porous inorganic particle.

20. The manufacturing method according to claim 19, wherein the porous inorganic particle is selected from the group consisting of synthetic noncrystalline silica, colloidal silica, vapor-phase silica, alumina, colloidal alumina, pseudo-boehmite, and boehmite.

21. The image protective sheet according to claim 1, wherein a hardness of the protective layer is a value of 2 H or greater, as measured by JIS Standard K5600.

22. The image protective solution according to claim 4, wherein the acrylic resin comprises polyacrylate.

23. The image protective solution according to claim 4, wherein the acrylic resin comprises polymethacrylate.

24. The image protective solution according to claim 4, wherein the acrylic resin is formed from a mixture of monomers selected from the group consisting of acryl, methacryl and styrene.
